(19) United States
(12) Patent Application Publication
(10) Pub. No.: US 2009/0207261 A1
(43) Pub. Date: Aug. 20, 2009

(54) ELECTRONIC DEVICE AND METHOD FOR OPERATING AN ELECTRONIC DEVICE

(75) Inventor: DAN DINESCU, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 12/034,245

(22) Filed: Feb. 20, 2008

(51) Int. Cl. H04N 5/232

(52) U.S. Cl. 348/208.6; 348/E05.042

(57) ABSTRACT

An electronic device including an interface configured to receive a first digital picture and a second digital picture generated by a digital camera, a determining circuit configured to detect a movement of the digital camera in a direction perpendicular to the image plane of the first digital picture based on differences between the first digital picture and the second digital picture, a generating circuit configured to generate control information depending on the detected movement, and a processing circuit configured to carry out an operation according to the control information.

### TECHNICAL FIELD

Embodiments relate generally to an electronic device and a method for operating an electronic device.

### BACKGROUND

With the increased usage of mobile electronic devices there is an increasing need for possibilities for controlling a mobile electronic device which are convenient for the user, can be provided at low costs and do not make use of parts which wear off.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the embodiments. In the following description, various embodiments are described with reference to the following drawings, in which:

FIG. 1 shows an electronic device according to an embodiment;

FIG. 2 shows a flow diagram according to an embodiment;

FIG. 3 shows a mobile terminal according to an embodiment;

FIG. 4 shows a mobile terminal according to an embodiment at a first time and the mobile terminal at a second time;

FIG. 5 shows a mobile terminal according to an embodiment at a first time and at a second time; and

FIG. 6 shows a flow diagram according to an embodiment.

### DESCRIPTION

The man-machine interface of mobile electronic devices, such as mobile communication terminals or PDAs (personal digital assistants), may be based on keyboards, keypads, or touch-screens. Also, but less frequently used, motion sensors may be provided in mobile electronic devices for input. For example, in case of a small mobile electronic device the input using a keyboard, for example for on-screen navigation, is uncomfortable and wears off the keys. Touch-screens are typically relatively expensive and may require a stylus or, if input is possible directly using the fingers, the screen may get dirty. Motion sensors may lead to increased costs of the electronic device. A very comfortable way to navigate on the screen is using a computer mouse to which a lot of users are already used from the usage of desktop computer. However, using a computer mouse for on-screen navigation for a mobile electronic device may be inconvenient for the users since another device has to be carried and a flat surface may be required for using the computer mouse. Thus, some of the mobility features of a mobile electronic device may be lost when using a computer mouse.

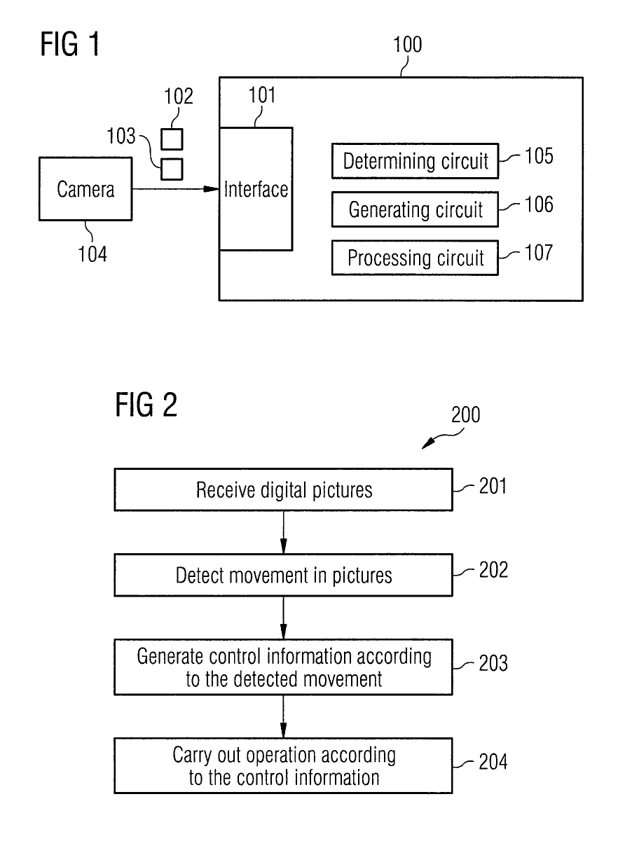

A lot of mobile electronic devices may be provided with a digital camera. For example, a lot of mobile communication terminals that are used include a digital camera. In one embodiment, the digital camera of an electronic device may be used as a basis for generating control information, for example for on-screen navigation, for the electronic device. An embodiment where this may be done is described in the following with reference to FIG. 1.

FIG. 1 shows an electronic device 100 according to an embodiment. The electronic device 100 may include an interface 101 configured to receive a first digital picture 102 and a second digital picture 103 generated by a digital camera 104, a determining circuit 105 configured to detect a movement of the digital camera 104 in a direction perpendicular to the image plane of the first digital picture 102 based on differences between the first digital picture 102 and the second digital picture 103, and generating circuit 106 configured to generate control information depending on the detected movement.

The electronic device 100 may further include a processing circuit 107 configured to carry out an operation according to the control information. The digital camera 104 is for example an internal camera of the electronic device 100. In this case, the detected movement is a movement of the electronic device 100 in a direction perpendicular to the image plane of the first digital picture. The digital camera 104 may also be an external camera which is coupled to the electronic device 100 wirelessly, e.g. using Bluetooth etc. or by cable, e.g. using a USB (Universal Serial Bus) connection. In this case, the digital camera 104 can be moved independently from the electronic device 100. For example, the electronic device 100 can be held still and the digital camera 104 can be moved to generate the control information.

In form of the differences between the first digital picture 102 and the second digital picture 103 the digital camera 104 delivers information to the electronic device 100 via the interface 101 about the movement of the scenery shown in the digital pictures 102, 103. If the digital pictures 102, 103 show unmoving objects, the detected movement corresponds to a movement of the digital camera 104.

The control information generated is for example used as input information for on-screen navigation. Thus, the digital camera 104 may be used as man-machine interface by moving it around.

In one embodiment, the digital camera is an internal camera, i.e. the electronic device includes the digital camera.

The electronic device may further include an input element and a detection circuit detecting whether the input element is activated and the processing circuit may be configured to carry out the operation when it has been detected that the input element is activated. Similarly, the determining circuit may be configured to detect the movement when it has been detected that the input element is activated. The input element is a button, for example.

In one embodiment, the electronic device includes a display and the operation is an on-screen navigation operation. For example, the operation may be a zooming operation. For example, if the detected movement is a movement of an object represented in the first digital picture and the second digital picture in the direction of the digital camera the generating circuit is configured to generate control information specifying to zoom in on the contents shown on the display and/or if the detected movement is a movement of an object represented in the first digital picture and the second digital picture away from the digital camera the generating circuit is configured to generate control information specifying to zoom out from the contents shown on the display.

In one embodiment, the operation is to enter a sub-menu or to exit a sub-menu in a hierarchical menu structure. For example, if the detected movement is a movement of an object represented in the first digital picture and the second digital picture in the direction of the digital camera the generating circuit is configured to generate control information specifying to enter the sub-menu and if the detected movement is a movement of an object represented in the first digital picture and the second digital picture away from the digital camera the generating circuit is configured to generate control information specifying to exit the sub-menu.

The control information may for example be used as input for an computer program executed by the processing circuit. The computer program is for example a document viewing program, an Internet browsing program, a file manager program or a computer game.

In one embodiment, the electronic device is a mobile electronic device such as a mobile communication terminal.

The determining circuit is for example configured to detect the movement using a motion estimation algorithm applied to the first digital picture and the second digital picture.

A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be software being implemented or executed by a processor, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In one embodiment a method for operating an electronic device is provided as illustrated in FIG. 2, which is for example carried out by the electronic device 100 shown in FIG. 1.

FIG. 2 shows a flow diagram 200 according to an embodiment.

In 201, a first digital picture and a second digital picture generated by a digital camera are received.

In 202, a movement of the digital camera in a direction perpendicular to the image plane of the first digital picture is detected based on differences between the first digital picture and the second digital picture.

In 203, control information is generated depending on the detected movement.

In 204, an operation is carried out, for example by the electronic device, according to the control information.

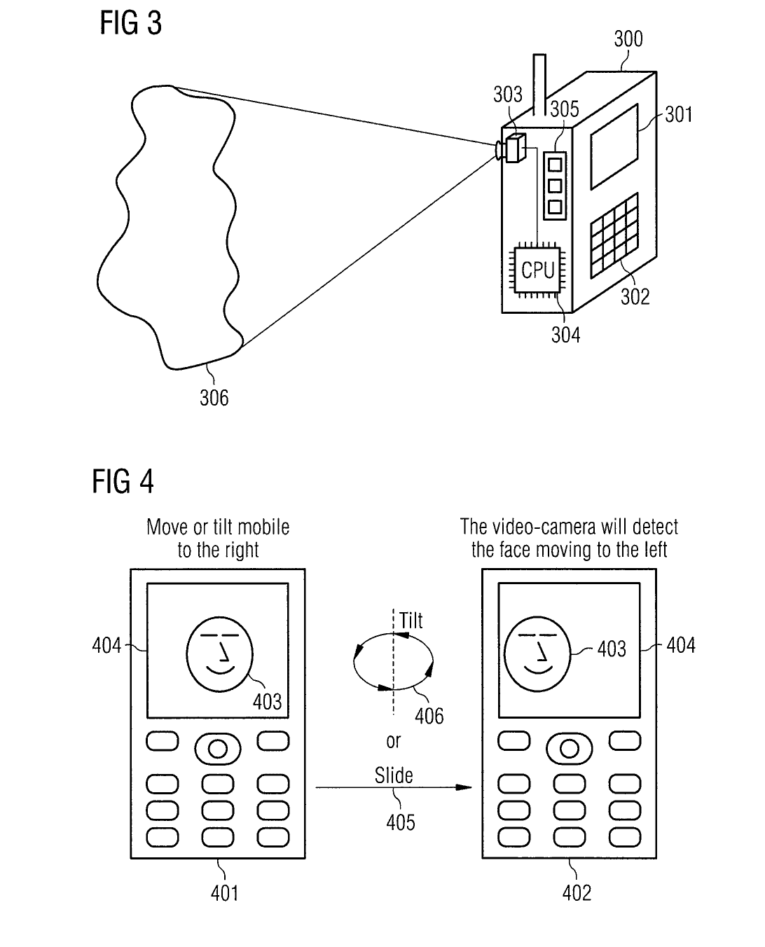

An example where the electronic device is a mobile communication terminal, for example a user terminal of a cellular mobile communication system such as an UMTS (Universal Mobile Telecommunications System) mobile communication system is described in the following with reference to FIG. 3.

FIG. 3 shows a mobile terminal 300 according to an embodiment.

The mobile terminal may include a display 301, for example an LCD (liquid crystal display) and a keypad 302. The mobile terminal may further include a digital camera 303 and a processing circuit in the form of a central processing unit (CPU) 304.

In this example, the digital camera 303 is the internal main camera of the mobile terminal 300. In another embodiment, an external digital camera is coupled via an interface, for example via a Bluetooth interface or an USB interface to the mobile terminal 300. An external digital camera may be used analogously as the internal digital camera 303 with the difference that the movement of the internal camera 303 is the same as the movement of the mobile terminal 300 but when an external digital camera is used the external digital camera and the mobile terminal 300 may be moved independently.

When the digital camera 300 is switched on it generates a plurality of digital pictures 305 of an object 306. From the plurality of digital pictures 305 the CPU 304 determines, e.g. by using an image processing algorithm for motion estimation, the relative movement of the mobile terminal 300 with respect to the object 306. From the detected movement, the CPU 304 may generate control information according to which an operation is carried out. For example, the CPU 304 may execute a document viewer program or internet browser program and according to the control information the section of the document or the webpage shown on the display 301 is changed, i.e. the display window is changed.

Different movements of the mobile terminal 300 with respect to the object 306 may be used to generate different control information. For example, a movement of the mobile terminal 300 in the direction of the object 306, i.e. a movement perpendicular to the image plane of the digital camera 303 causes the CPU to generate control information according to which the document or webpage shown on the display 301 is zoomed in. Accordingly, a movement of the mobile terminal 300 away from the object 306 may cause the display window to zoom out from the document shown. A sideward movement of the mobile terminal 300 with respect to the object 306 may give rise to a corresponding sideward movement of the display window and a rotation of the mobile terminal 300 with respect to the object 306 may cause the display window to rotate analogously.

Other control information than for the movement of a display window may also be generated depending on the movement of the mobile terminal 300 with respect to the object 306. For example, a movement of the mobile terminal 300 into the direction of the object 306 may also cause menus to be activated and a movement away from the object 306 may cause the exit of a sub-menu, i.e. the return to an upper level in a hierarchical menu structure. Depending on the application carried out which, in addition to a document viewer or internet browser program may also be another application such as a computer game, an image viewing program, or a file managing program, the movements of the mobile terminal 300 with respect to the object 306 may be translated into various commands.

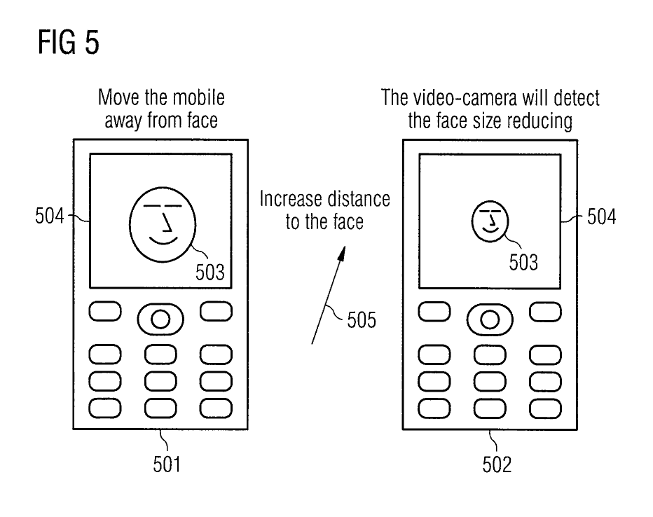

Examples of movements of the mobile terminal 300 with respect to the object 306 are illustrated in FIGS. 4 and 5.

FIG. 4 shows a mobile terminal according to an embodiment at a first time 401 and the mobile terminal at a second time 402.

In this example, the object 306 is a face which is in this example shown as a representation 403 on the display 404 corresponding to the display 301 of the mobile terminal 401, 402. The representation 403 is shown on the display 404 such that the relative movement between the mobile terminal 401, 402 and the object 403 may be illustrated. The representation may or may not be shown on the display 403 according to embodiments.

A slide movement of the representation 403 in the digital pictures generated by the digital camera 303, i.e. a slide movement of the object 403 from one digital picture generated by the digital camera 303 to a subsequent digital picture generated by the digital camera 303 can be achieved by a slide movement of the mobile terminal 300 with respect to the object 306 or a tilting movement of the mobile terminal 300 with respect to the object 306. This is illustrated in FIG. 4: If the mobile terminal 300 is moved to the right as indicated by a first arrow 405 or is tilted with respect to the object 306 as indicated by a second arrow 406 the representation 403 of the object 306 moves to the left in the digital pictures generated or, in this case where the digital pictures are shown on the display 404, the representation 403 moves to the left on the display 404.

FIG. 5 shows a mobile terminal according to an embodiment at a first time 501 and at a second time 502. Similarly to FIG. 4, a representation 503 of the object 306 is shown on the display 504 corresponding to the display 301 of the mobile terminal 300. If the mobile terminal 300 is moved away from the object 306 such that the distance between the mobile terminal 300 and the object 306 increases as indicated by arrow 505 in FIG. 5 the representation 503 of the object in the sequence of digital pictures and in this case on the display 504 becomes smaller.

The movement of the mobile terminal 300 with respect to the object 306 may be translated into a corresponding movement for on-screen navigation, for example movement of the section of a document shown on the screen 301. The amplitude of the on-screen movement may be determined from the amplitude of the actual movement, i.e. the amplitude of the movement between the mobile terminal 300 and the object 306 using a scaling factor. The actual movement may be translated into an on-screen position, e.g. the section of a document shown would move to a certain position of the document, or a movement direction, e.g. a movement of the mobile terminal 300 with respect to the object 306 would result into a scrolling of the section shown such that the user may stop the movement when the section of the document is the one the user wants to see.

Since the digital camera 303 requires power for generating the digital pictures 305 in one embodiment, the digital camera 303 is in one embodiment only activated when digital pictures 305 should be generated, e.g. for generating control information. For example, the mobile terminal 300 includes a special button and when this button is pressed, the generation of digital pictures 305 by the digital camera 303 is activated and movement is detected. Thus, the user can press the button when he wishes to use the digital camera 303 for on-screen navigation (or generally for generating control information) and the digital camera 303 only consumes power when needed. In addition, when the button is not pressed, the movement of the mobile terminal 300 does not lead to the generation of control information. For example, by releasing the button, the user can freely move the mobile terminal 300 around without causing the contents of the display 301 to be changed according to the movement.

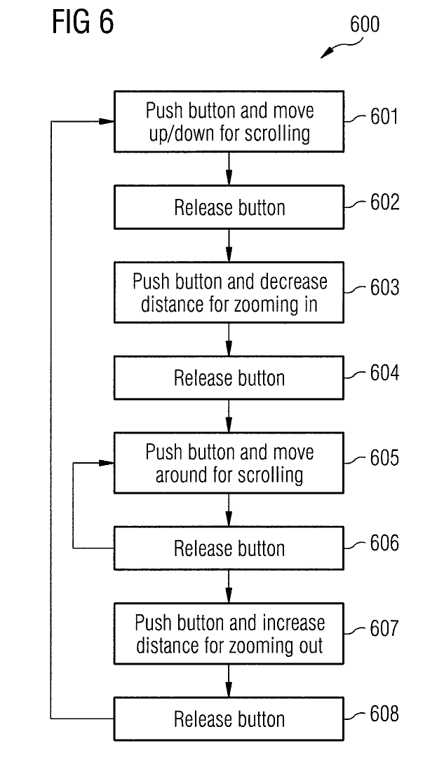

In the following, an example for the usage of the mobile terminal 300 for internet browsing wherein movements detected from digital pictures are used for on-screen navigation is explained with reference to FIG. 6.

FIG. 6 shows a flow diagram 600 according to an embodiment.

It is assumed that the user of the mobile terminal 300 has accessed the internet and a webpage has been opened in a browser program.

In 601, the user pushes a button that causes the digital camera 303 to be activated and to generate the digital pictures 305 of the object 306 and the CPU 304 to detect movement in the plurality of digital pictures 305 and to generate corresponding control information and moves the mobile terminal 300 upwards or downwards to scroll the webpage (i.e. scroll the display window showing a section of the webpage) until the place of interest is reached. In 602, the user releases the button and brings the mobile terminal 300 back to its original position.

In 603, the user pushes the button again and moves the mobile terminal 300 in the direction of the object 306 to zoom in on the section of the webpage that is displayed. When the desired detail level (or zoom level) has been reached the user releases the button in 604 and brings the mobile terminal 300 back to its original position.

In 605, when the user has finished reading the screen content he again pushes the button and moves the mobile around for scrolling around on the webpage. The user for example carries out slide movements or tilt movements of the mobile terminal 300 with respect to the object 306 for doing this.

In 606, when the desired position on the webpage has been reached he releases the button and moves the mobile terminal 300 back to its original position (or any other convenient position). If he likes, the user can repeat 605 and 606 for further viewing the webpage.

In 607, when the user wants to get back to an overview over the webpage, he increases the distance between the object 306 and the mobile terminal 300 such that the display zooms out while pushing the button.

The user releases the button 608 when the display has zoomed out to a desired level and continues with 601, possibly after he has opened a different webpage or to view a different section on the webpage. As mentioned above, the increase/decrease of the distance between mobile terminal 300 and the object 306 may be used for zooming operations but also for entering and leaving sub menus in a menu structure. For example, a movement of the mobile terminal 300 into the direction of the object 306 by a certain degree causes a menu whose name is highlighted (the selection of the menu whose name is highlighted could for example be achieved by an up/down movement) to be entered. Similarly, a movement of the mobile terminal 300 away from the object 306 may cause control information to be generated such that a sub-menu is left to return to a higher level of the menu structure.

In the example shown in FIG. 3, the digital camera 303 points away from the display 301. In an embodiment where the digital camera 303 faces into the same direction as the display 301 (which may for example be done using an external camera) the user may use his own face as object 306. In this case, for example for zooming into a webpage, he may move the mobile terminal 300 closer to his face. This means that by moving the display nearer to his face the contents of the display are shown larger which may be considered as being the intuitional thing for getting a more detailed view.

While the embodiments have been shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An electronic device comprising:
an interface configured to receive a first digital picture and a second digital picture generated by a digital camera;
a determining circuit configured to detect a movement of the digital camera in a direction perpendicular to the image plane of the first digital picture based on differences between the first digital picture and the second digital picture;
a generating circuit configured to generate control information depending on the detected movement; and
a processing circuit configured to carry out an operation according to the control information.

2. The electronic device according to claim 1, wherein the electronic device comprises the digital camera.

3. The electronic device according to claim 1, wherein the electronic device comprises an input element and a detection circuit configured to detect whether the input element is activated, and wherein the processing circuit is configured to carry out the operation when it has been detected that the input element is activated.

4. The electronic device according to claim 3, wherein the determining circuit is configured to detect the movement when it has been detected that the input element is activated.

5. The electronic device according to claim 4, wherein the input element is a button.

6. The electronic device according to claim 1, wherein the electronic device comprises a display and the operation is an on-screen navigation operation.

7. The electronic device according to claim 6, wherein the operation is a zooming operation.

8. The electronic device according to claim 7, wherein if the detected movement is a movement of the digital camera in the direction of an object represented in the first digital picture and the second digital picture, the generating circuit is configured to generate control information specifying to zoom in on the contents shown on the display.

9. The electronic device according to claim 7, wherein if the detected movement is a movement of the digital camera away from an object represented in the first digital picture and the second digital picture, the generating circuit is configured to generate control information specifying to zoom out from the contents shown on the display.

10. The electronic device according to claim 6, wherein the operation is to enter a sub-menu or to exit a sub-menu in a hierarchical menu structure.

11. The electronic device according to claim 10, wherein if the detected movement is a movement of the digital camera in the direction of an object represented in the first digital picture and the second digital picture, the generating circuit is configured to generate control information specifying to enter the sub-menu.

12. The electronic device according to claim 10, wherein if the detected movement is a movement of the digital camera away from an object represented in the first digital picture and the second digital picture the generating circuit is configured to generate control information specifying to exit the sub-menu.

13. The electronic device according to claim 1, wherein the control information is used as input for a computer program executed by the processing circuit.

14. The electronic device according to claim 13, wherein the computer program is a document viewing program, an Internet browsing program, a file manager program or a computer game.

15. The electronic device according to claim 1, wherein the electronic device is a mobile electronic device.

16. The electronic device according to claim 15, wherein the electronic device is a mobile communication terminal.

17. The electronic device according to claim 1, wherein the determining circuit is configured to detect the movement using a motion estimation algorithm applied to the first digital picture and the second digital picture.

18. A method for operating an electronic device comprising:
receiving a first digital picture and a second digital picture generated by a digital camera;
detecting a movement of the digital camera in a direction perpendicular to the image plane of the first digital picture based on differences between the first digital picture and the second digital picture;
generating control information depending on the detected movement; and
carrying out an operation according to the control information.

19. The method according to claim 18, wherein the electronic device comprises an input element, and the method further comprises detecting whether the input element is activated and carrying out the operation if it has been detected that the input element is activated.

20. The method according to claim 19, further comprising detecting the movement if it has been detected that the input element is activated.

21. The method according to claim 19, wherein the operation is an on-screen navigation operation.

22. The method according to claim 19, wherein the operation is a zooming operation.

23. An electronic device comprising:
a digital camera configured to generate a first digital picture and a second digital picture;
a determining circuit configured to detect a movement of the electronic device in a direction perpendicular to the image plane of the first digital picture based on differences between the first digital picture and the second digital picture;
a generating circuit configured to generate control information depending on the detected movement; and
a processing circuit configured to carry out an operation according to the control information.

24. A computer program product which, when executed by an electronic device, makes the electronic device carry out a method for operating the electronic device comprising:
receiving a first digital picture and a second digital picture generated by a digital camera;
detecting a movement of the digital camera in a direction perpendicular to the image plane of the first digital picture based on differences between the first digital picture and the second digital picture;
generating control information depending on the detected movement; and
carrying out an operation according to the control information.

25. An electronic device comprising:
receiving means for receiving a first digital picture and a second digital picture generated by a digital camera;
detecting means for detecting a movement of the digital camera in a direction perpendicular to the image plane of the first digital picture based on differences between the first digital picture and the second digital picture;
generating means for generating control information depending on the detected movement; and
a processing means for carrying out an operation according to the control information.
